(19) United States
(12) Patent Application Publication
(10) Pub. No.: US 2017/0185954 A1
(43) Pub. Date: Jun. 29, 2017

(54) MOBILE AERIAL RFID SCANNER

(71) Applicant: Clarke William McAllister, Eugene, OR (US)

(72) Inventor: Clarke William McAllister, Eugene, OR (US)

(21) Appl. No.: 15/393,499

(22) Filed: Dec. 29, 2016

Related U.S. Application Data
(63) Continuation-in-part of application No. 15/286,560, filed on Oct. 6, 2016.
(60) Provisional application No. 62/238,105, filed on Oct. 6, 2015.

(51) Int. Cl. G06Q 10/08; G06K 19/077; G06K 7/10

(52) U.S. Cl. CPC G06Q 10/087; G06K 7/10376; G06K 19/07758

(57) ABSTRACT

The present invention relates to a mobile aerial RFID scanning platform and teaches how to overcome fundamental challenges related to the scanning of items that are tagged with radio frequency identification (RFID) tags. Improved RFID antennae, localization, robotic navigation, and robotic RFID scanning are taught by the present invention as an improvement over prior art.

### RELATED APPLICATIONS

The present application is a continuation-in-part application of co-pending U.S. patent application Ser. No. 15/286,560 filed on 6 Oct. 2016 and of Ser. No. 14/311,215 filed 20 Jun. 2014 that claims priority and benefit based on co-pending U.S. patent application Ser. No. 13/693,026 filed on 3 Dec. 2012 by the same inventor Clarke W. McAllister. The present application also claims priority and benefit under 35 USC Section 119(e), all by the same inventor Clarke W. McAllister, the disclosures of which are expressly incorporated herein by reference. Also for U.S. patent application Ser. No. 15/286,560 expired provisional patent for 62/238,105 filed on 6 Oct. 2015 is claimed for benefit and priority under 35 USC Section 119(e). Also the following expired provisional patents for U.S. patent application Ser. No. 13/693,026 for which are claimed benefit and priority under 35 USC Section 119(e): U.S. Provisional Application Nos. 61/567,117 filed 5 Dec. 2011, and 61/677,470 filed 30 Jul. 2012, and 61/708,207 filed 1 Oct. 2012, and of 61/709,771 filed 4 Oct. 2012, all by the same inventor Clarke W. McAllister. Also The U.S. patent application Ser. No. 14/311,215 claims the benefit under 35 USC Section 119(e) of U.S. Provisional Application Nos. 61/838,186 filed 21 Jun. 2013, and 61/879,054 filed 17 Sep. 2013, and 61/989,823 filed 7 May 2014, and 61/567,117 filed 5 Dec. 2011, and 61/677,470 filed 30 Jul. 2012, and 61/708,207 filed 1 Oct. 2012, and of 61/709,771 filed 4 Oct. 2012, all by the same inventor Clarke W. McAllister.

### BACKGROUND

The present invention relates to an automated inventory scanning system, including methods and devices utilizing novel aerial scanning antennae, robots, unmanned aerial vehicles, and RFID (radio-frequency identification) transponders.

Robots are disclosed for aerial scanning using either propellers to lift an unmanned aerial vehicle (UAV), or a scissor lift mounted to a two-wheeled robot for maneuvering an RFID antenna to vertical storage spaces that are located well above floor level.

Radio-frequency identification (RFID) transponders enable improved identification and tracking of objects by encoding data electronically in a compact tag or label. Radio-frequency identification (RFID) transponders, typically thin transceivers that include an integrated circuit chip having radio frequency circuits, control logic, memory and an antenna structure mounted on a supporting substrate, enable vast amounts of information to be encoded and stored and have unique identification.

RFID transponders rank into two primary categories: active (or battery assist) RFID transponders and passive RFID transponders. Active RFID transponders include an integrated power source capable of self-generating signals, which may be used by other, remote reading devices to interpret the data associated with the transponder. Active transponders include batteries and, historically, are considered considerably more expensive than passive RFID transponders. Passive RFID transponders backscatter incident RF energy to remote devices such as interrogators.

Reflections from shelving and other metal objects in the field of an RFID reader are can blind and possibly saturate baseband amplifiers preventing tag reading. Circularly polarized antennae have nulls that result in little or no ability to read linearly polarized RFID transponders at certain distance intervals from the antenna. Aerial RFID scanning also introduces significant ground-bounce problems that also result in poor RFID transponder interrogation performance. These and other problems are overcome by the presently disclosed invention. No prior art comprehensively teaches systems, methods or devices for moving among, overcoming carrier reflections, nulls, and ground bounce to automatically determine the location of RFID-tagged inventory.

### SUMMARY OF THE INVENTION

In the present invention seven important problems are solved to make RFID inventory counting and localization a commercial reality for retail stores engaging in omnichannel retailing, including and especially for retailers that want to use their retail sales for as a forward warehouse for fulfillment of consumer's online orders for same day delivery or in-store pickup. In these highly competitive retail environments such as this, inventory errors can result in disastrous customer relationship problems when a retailer promises delivery or pickup of an item that is not actually in stock, ready to hand over to a waiting customer. Therefore it is in this context that the following eight solution criteria make sense from a retail business perspective: push-button inventory, safety, high availability, quiet operation, minimal disturbance to sales floor, centimeter location accuracy, and low capital expense.

Several prior art solutions, including those taught by the present inventor have not offered solutions that perform as well against these eight criteria as well as the present invention.

Push-button inventory solutions are achieved when RFID tags are read automatically. This usually means that some sort of RFID tag scanning is used. RF beams are either fixed or moving. Moving beams are either mechanically or electronically steered to various locations and vector angles. The present invention uses an electro-mechanical beam positioning system to steer RF interrogation beam(s), preferably to illuminate and interrogate each RFID tag without incurring direct labor to do so. Robotic solutions are used and optimal robotic mobility is used through aerial RFID scanning.

Safe movement of a robot requires separation of people and object from fast-moving parts of the robot, including the robot itself. In the present invention the requirements for overcoming the force of gravity to lift an move the mass required to form a beam, transmit RF energy, and collect RFID tag data is best achieved by employing lift from a scissor lift apparatus. In the present invention a modified Quadix antenna provides beam focusing from a high gain antenna that weighs only about 3-5 ounces.

High availability is realized by the present invention by a two-wheeled robot that rolls through tagged inventory items and elevates a rotating scanning antenna to various altitudes of interest.

In retail sales environments a two-wheeled robot operates very quietly, having no loud moving parts.

Propeller wash is a blast of air that interferes with the shopping process by distracting shoppers and displacing retail inventory and displays. The present invention achieves this important design requirement by eliminating propellers. In the present invention the RFID scanning antenna is lifted to various altitudes by an expanding mechanical apparatus.

Centimeter accuracy enables high-resolution item localization accuracy.

Low capital expense relative to large arrays of fixed RFID readers is obvious, such solutions do not scale nearly as well as the present invention. That is because a single robot can read RFID tags over a much greater area than even the best long-range RFID readers. RF beam-steered RFID readers also have a high cost of the equipment and the wiring that is required to power them.

The present invention discloses devices for automatically reading and locating RFID-tagged assets including retail goods, automobiles, and commercial transport trailers.

Herein the term ‘robot’ is used interchangeably throughout this specification and the associated claims to mean either a rolling robot or a flying robot, such as a UAV, except where a specific meaning is explicitly stated.

Robots of the present invention are optimized and disclosed and claimed for reading RFID tags in retail store environments where metal display racks and shelves reduce the read rate and inventory accuracy of systems that fail to avoid blinding reflections from typical indoor propagation environments. The present invention overcomes limitations of prior art by avoiding unwanted carrier signal reflection paths by using novel scanning devices, features, and methods.

### DRAWINGS

FIG. 1 is a directional dual-elliptical UHF RFID antenna according to one embodiment of the present invention.

FIG. 2 is a directional UHF RFID antenna with pitch and yaw axis directional mobility according to one embodiment of the present invention.

FIG. 3 is a beam pattern of the vertically polarized antenna structure.

FIG. 4 is a beam pattern of the horizontally polarized antenna structure.

FIG. 5 is an RF model of a directional dual-elliptical UHF RFID antenna according to one embodiment of the present invention.

FIG. 6 is an RF model of a directional dual-elliptical UHF RFID antenna having a linear horizontal beam-forming element according to one embodiment of the present invention.

FIG. 7 is a two-wheeled robot with a scissor lift for aerial positioning of a directional UHF RFID antenna according to one embodiment of the present invention.

FIG. 8 is an unmanned aerial vehicle (UAV) with an aerial RFID antenna according to one embodiment of the present invention.

FIG. 9 is a directional dual-elliptical UHF RFID antenna with a laser line according to one embodiment of the present invention.

FIG. 10. Is an expandable carbon fiber folding structure for an aerial lift mechanism according to one embodiment of the present invention.

### DESCRIPTION OF THE INVENTION

Making reference to various figures of the drawings, possible embodiments of the present invention are described and those skilled in the art will understand that alternative configurations and combinations of components may be substituted without subtracting from the invention. Also, in some figures certain components are omitted to more clearly illustrate the invention, similar features share common reference numbers.

To clarify certain aspects of the present invention, certain embodiments are described in a possible environment—as identification means for retail items that are bought and used by consumers. In these instances, certain methods make reference to items such as clothing, garments, shoes, consumables, electronics, and tires, but other items may be used by these methods. Certain embodiments of the present invention are directed for identifying objects using RFID transponders in supply chains, retail stores, warehouses, and distribution centers—both indoors and outdoors.

Some terms are used interchangeably as a convenience and, accordingly, are not intended as a limitation. For example, transponder is a term for wireless sensors that is often used interchangeably with the term tags and the term inlay, which is used interchangeably with inlet. This document generally uses the term tag or RF tag to refer to passive inlay transponders, which do not include a battery, but include an antenna structure coupled to an RFID chip to form an inlay which is generally thin and flat and substantially co-planar and may be constructed on top of a layer of foam standoff, a dielectric material, or a folded substrate. One common type of passive inlay transponder further includes a pressure-sensitive adhesive backing positioned opposite an inlay carrier layer. Chipless RFID transponders are manufactured using polymers instead of silicon for cost reduction. Graphene tags offer similar benefits. Inlays are frequently embedded in hang tags, pocket flashers, product packaging, and smart labels. A third type: a battery-assist tag is a hybrid RFID transponder that uses a battery to power the RFID chip and a backscatter return link to the interrogator.

The systems, methods, and devices of the present invention utilize an RFID transponder or wireless sensors as a component. Certain RFID transponders and wireless sensors operate at Low Frequencies (LF), High Frequencies (HF), Ultra High Frequencies (UHF), and microwave frequencies. HF is the band of the electromagnetic spectrum that is centered around 13.56 MHz. UHF for RFID applications spans globally from about 860 MHz to 960 MHz. Transponders and tags responsive to these frequency bands generally have some form of antenna. For LF or HF there is typically an inductive loop. For UHF there is often an inductive element and one or more dipoles or a microstrip patch or other microstrip elements in their antenna structure. Such RFID transponders and wireless sensors utilize any range of possible modulation schemes including: amplitude modulation, amplitude shift keying (ASK), double-sideband ASK, phase-shift keying, phase-reversal ASK, frequency-shift keying (FSK), phase jitter modulation, time-division multiplexing (TDM), or Ultra Wide Band (UWB) method of transmitting radio pulses across a very wide spectrum of frequencies spanning several gigahertz of bandwidth. Modulation techniques may also include the use of Orthogonal Frequency Division Multiplexing (OFDM) to derive superior data encoding and data recovery from low power radio signals. OFDM and UWB provide a robust radio link in RF noisy or multi-path environments and improved performance through and around RF absorbing or reflecting materials compared to narrowband, spread spectrum, or frequency-hopping radio systems. Wireless sensors are reused according to certain methods disclosed herein. UWB wireless sensors may be combined with narrowband, spread spectrum, or frequency-hopping inlays or wireless sensors.

A common cause for RFID tags to not read is for a tag to be located at a null in the carrier field. Nulls typically occur at several points along a beam path between the interrogation antenna and the RFID transponder. Circularly polarized antenna exhibit the problem of vector rotation wherein the propagating electric field from the antenna rotates along a spiral path. If the electric field vector aligns with the transponder's strongest polarization, then the tag will readily read. On the contrary, if the field vectors are misaligned, the tags will not read with high probability.

An operational solution to this problem is to scan again from a different angle and or distance for reducing location errors.

Referring to FIG. 10, a preferred beam forming solution is to use dual elliptical antenna 10. It is a high gain circularly polarized four-element Quadix antenna, which is an improved antenna that is derived from a much larger, and heavier prior art 146 MHz Ham radio design by Ross Anderson W1HBQ. Antenna 10 has advantages such as minimal weight and minimal wind load due to its small surface area. Wind load force is calculated as one-half of the density of air times the velocity squared times the surface area presented to the wind. Antenna 10 has a reduced surface area, which when computed over the entire structure on all sides is about 150 square inches.

Preferred embodiments of antenna 10 uses 16 AWG half-hard brass wire for the elements. The total weight is about five ounces, and when weighed in grams in any case is less than 200 grams. With respect to a UAV, these are advantages over a high gain patch or panel antennae, a Yagi-Uda, or a conventional helix with the large reflector that it requires.

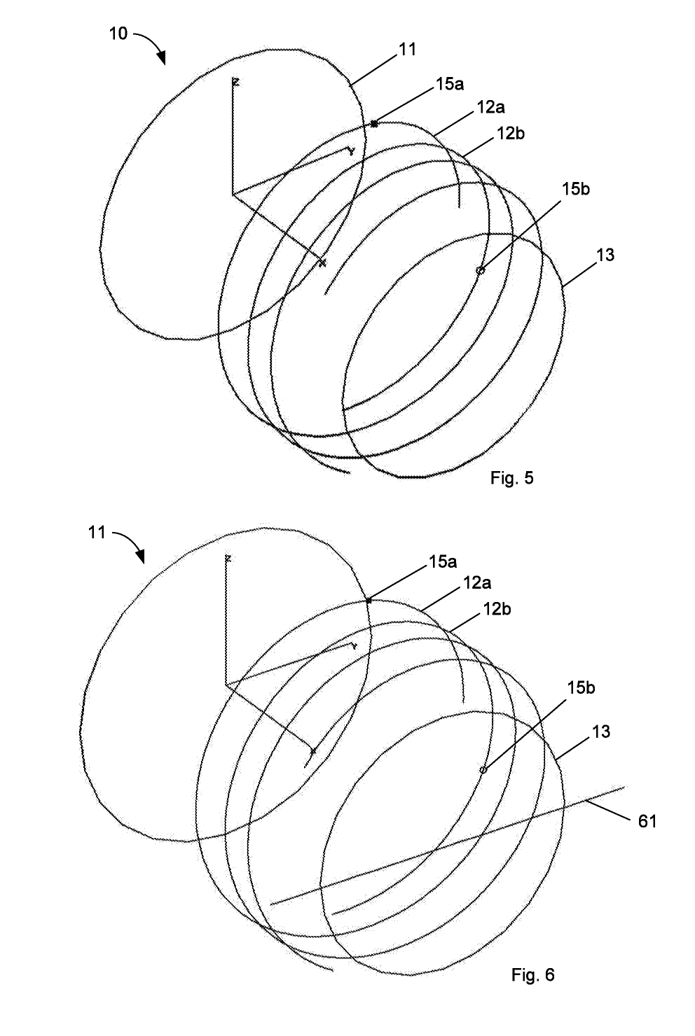

This novel antenna, designed for aerial RFID scanning is also related to a bifilar helical antenna wherein its traditional metal ground plane reflector that is typically used in prior art helical antennae, is replaced by the combination of toroidal reflector loop 11 and one or more director toroidal loops 13. FIG. 5 shows an RF model for that embodiment. In another preferred embodiment a director is formed by a second toroid-shaped loop having a smaller diameter than the reflector loop. In another preferred embodiment, the second director is linear re-radiating element 61, which is a linear horizontal beam-forming element as shown in the RF model of FIG. 6.

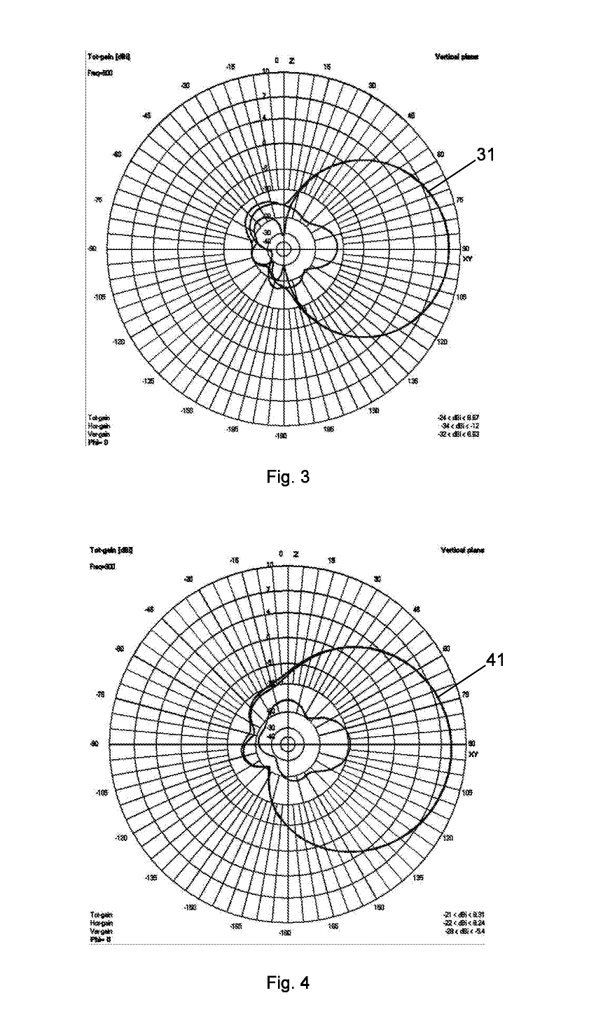

Referring now to FIGS. 3 and 4 the radio frequency beam patterns are shown. FIG. 3 shows beam pattern 31 for the vertical antenna, and FIG. 4 shows beam pattern 41 for the horizontal antenna.

Additional directors may be added to further enhance the beam forming. In a preferred embodiment, two, three, four or more linear metallic director elements are used to reduce the ellipticity of the vertical and/or horizontal polarized wave fronts, thus resulting in more linear wave fronts. Linear wave fronts have the advantage of consistent alignment of tag and antenna polarizations, regardless of distance along the beam path.

The two exciters are fed by two different ports of an RFID reader interrogator such as the ThingMagic M6e-Micro. In a preferred embodiment, antenna port 1 is connected through coax cable 14a to balun board 15a of vertical exciter 12a, and antenna port 2 is connected through coax cable 14b to balun board 15b of horizontal exciter 12b. The balun is a bi-directional electrical device that converts radio frequency signals from balanced to an unbalanced signal. Preferred embodiments also use an impedance-matching circuit on the unbalanced side of the balun to match the impedance of the balun to a 50 ohm impedance: 50+j0 ohms. Preferred balun boards use a 4:1 balun, which would for example have a 200 ohm impedance on the balanced side and a 50 ohm impedance on the unbalanced side. The balun boards would also preferably have a matching network such as an L or PI network using capacitors and inductors to match the impedances, including a 50-ohm impedance for the coaxial cable that connects the exciter to one port of the RFID interrogator. The preferred result is a low return loss of lower than −20 dB at selected frequencies within the 860-960 MHz range. In a preferred embodiment, the return loss for each antenna is less than −10 dB across the 902-928 MHz band, and a return loss of −25 dB at 915 Mhz. Also preferably, the horizontal and vertical polarizations preferably at any distance are within 2 dB of each other. In a dual-linear or dual elliptical antenna, the dominant polarizations are compared, specifically the vertical polarization of the vertical antenna compared to the horizontal polarization of the horizontal antenna.

The reflector and exciters have nominal diameters of 4.6 inches and the director has a nominal diameter of 3.8 inches. The exciter helical spacing is nominally 1.2 inches. Antenna elements, including the exciters, reflector, director(s), and balun boards are retained in place by a structure, preferably comprising plastic, such as acetyl copolymer, also known by the popular trade name Delrin. The plastic structure is preferably attached a to UAV using a mount such as a GoPro mount through an adapter that engages with mounting slot pair 17.

In another preferred embodiment, a conductive back plate is positioned near or within the region of the reflector ring, both sharing a common central axis that is aligned with the major axis of the antenna. The back plate provides a mounting surface for coax connectors such as MMCX connectors for external connection of the antenna to a dual-port RFID reader such as the ThingMagic M6e-Micro for interrogation of RFID transponders.

In another preferred embodiment the ThingMagic M6e-Micro reader interrogator is embedded within antenna 10. For improved serviceability, it can be easily removed. Preferred embodiments use thermally conductive materials to conduct heat away from the interrogator by making solid contact with its backplane and maintains a profile in the central core that runs in parallel with the major lines of near field magnetic flux from the reflector ring forward towards the director ring.

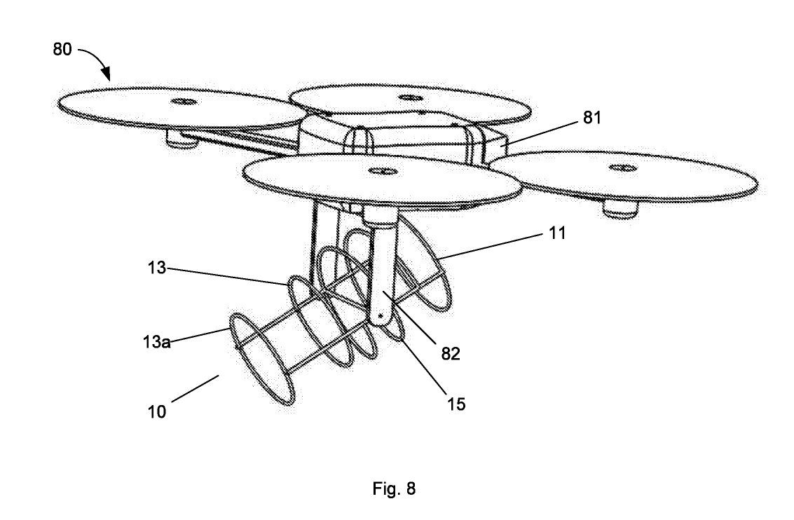

An unmanned aerial vehicle (UAV) 80 of FIG. 8 provides X, Y, Z, rho, theta, phi freedom of aerial mobility. There are several UAV platforms including quadracopters, tri-copters, hexacopters, octocopters, and helicopters, that are adapted to carrying a UHF RFID reader 81 and directional antenna 10 for interrogation of RFID transponders.

Aerial robot 80 is preferably fabricated from molded plastic and machined aluminum fittings for the UAV frame and housing of the autopilot and RFID reader 81. Motors turn propellers (shown as a blur as if in rotation) to provide lift, propulsion and to control pitch, roll, and yaw. Commercially available quadcopters such as the Sky-Hero and multicopters from Align represent aerial platforms that are suitable for constructing aerial robot 80.

Aerial robot 80 is capable of movement in any direction and in preferred embodiments implements a scan pattern comprising vertical movements between vantage points.

The autopilot preferably contains a 3-axis accelerometer, gyroscope, digital compass, barometer, and CPU. Preferred Pixhawk PX4 embodiments use an ST Micro LSM303D MEMS accelerometer/magnetometer. The Pixhawk PX4 autopilot from Pixhawk.org is representative of this type of autopilot. It uses a 168 MHz/252 MIPS Cortex-M4F ARMv7E-M CPU with a floating-point unit. The PX4 also has 14 pulse width modulation (PWM) outputs to servo-control motors and control surfaces, including quad electronic speed control (ESC). In addition to serving navigation and control loop inputs, the accelerometer is preferably used to report the Z-axis angular attitude of aerial robot 80 and through a known offset angle, the vertical angular component of antenna 10 relative to the earth's gravitational field. The attitude of aerial robot 80 is preferably reported to a data collector, preferably using either a serial port (either synchronous or asynchronous) or a universal serial bus (USB).

The data collector is preferably at least comprised of a 32-bit CPU and 512M bytes of RAM that are preferably combined into a single module such as the Broadcom BCM2835 700 MHz ARM1 176JZFS. A clock is used to time RFID data acquired from the RFID interrogator and aerial robot 80 attitude reports.

The CPU of the data collector preferably receives an asynchronous stream of RFID tag data from the RFID interrogator that in a preferred embodiment is a ThingMagic M6e-Micro, capable of sending data at a rate of up to 750 tag records per second. Tag read records preferably include Meta data such as RSSI and are preferably recorded in memory, including duplicate tag identification numbers. This is unlike prior art RFID tag readers such as handheld RFID tag readers in that prior art typically use a hash table or similar means to deduplicate tag sightings so that only a single tag sighting is reported, sometimes also with a count of the number of times that it was seen by the reader. In the present invention the CPU uses a time clock to timestamp tag sightings before they are stored in memory. In a preferred embodiment, the CPU and memory are combined within a single device such as the Broadcom BCM2835.

Memory preferably holds records of each tag read and their corresponding timestamp. Estimated flight position and attitude of aerial robot 80 are also recorded with timestamps. Preferred embodiments also run a flight pattern of rows along various headings in order to enhance RFID tag location data sets recorded in memory. Each point where RFID scan data is collected is a vantage point.

Vantage point computations preferably consider the downward angle of antenna 10 relative to the top plane of aerial robot 80 as shown in FIG. 8. Except when hovering in one place, aerial robot 80 also has angular offsets in pitch, roll, and yaw that must be considered. The gain and resulting beam shape of antenna 10 also determines the amount of angular uncertainty for each RFID tag reading.

A vital characteristic of the directional antenna is that it be both very light and have a minimal surface area in order to reduce wind load. Wind load is particularly important with respect to air rushing past the UAV's propellers and applying wind load pressure on the antenna, which increases the load on the UAV. Wind load is also a risk when operating the UAV scanner outdoors or in an area with large fans for air circulation, such as large industrial warehouses. Weight is always a concern for aircraft design; the antenna is a payload for the UAV aircraft to carry. Therefore, less weight is better. The present invention discloses an antenna that uniquely meets these vital characteristics.

GPS signals are preferably used for guiding robots while reading inventory such as cars in outdoor automobile lots.

There are many indoor locations where GPS signal strengths are too low for indoor GPS guidance. This section teaches solutions to that problem by using location references within the volume that is scanned for RFID-tagged inventory items. Unlike GPS, the scan volume may be indoors and/or outdoors.

The instant invention discloses location references that send or receive sonar pulses or send/receive laser light in order to provide location and heading information for robots.

The stationary location references have locations within a constellation map that is communicated to the robot. In a preferred embodiment, the three dimensional location of each stationary location reference are compiled to create a constellation map. The constellation map is preferably communicated to each robot via Wi-Fi. In a preferred embodiment, the constellation map of location references is transmitted using either TCP or UDP packets. Using UDP packet, the constellation maps are broadcast such that each mobile device in the vicinity can use an internal dictionary or database to lookup the location of each location reference by its designator number.

Preferred embodiments of robot 70 or UAV 80 use one or more VL53LOX laser ranging modules from ST. Each has a 940 nm VCSEL emitter (Vertical Cavity Surface-Emitting Laser) for a Time-of-Flight laser ranging module. It measures the distance to objects that reflect light, at ranges of up to 2 meters. Preferred embodiments use these small sensors to sense people and objects in the environment around robot 70 or UAV 80. They offer a key advantage for retail store scanning applications because the VL53LOX will sense fabric items such as saleable retail store apparel that would not be detectable by sonar sensors.

In other preferred embodiments sonar or ultrasonic ranging is used to measure time-of-flight of sound bursts referred to as pings. When a sound transmitter and a receiver are in the same place it is monostatic operation. When the transmitter and receiver are separated it is bistatic operation. When more transmitters (or more receivers) are spatially separated, it is called multistatic operation. The present invention uses all three types, each wherein a sonar transmitter creates a pulse of sound called a “ping”, and the sonar receivers listen for the ping. This pulse of sound is created using outputs from electronic circuits. A beamformer is used to concentrate the acoustic power into a beam.

In the present invention, to measure the distance from robot 70 to a node, the time from transmission of a ping to a reception node is measured and converted into a range by knowing the speed of sound. To measure the bearing or attitude, estimates are made using the rotation of robot 70 and from the directional beams from each of the sonar transmitter transducers.

The location of robot 70 is accurately determined using at least four of the sonar receiving nodes that listen for sonar pings from robot 70 ultrasonic transmitter array. The locations of each of the reception nodes is first determined using surveying tools including laser range finders, tape measures, or ultra wideband time-of-flight localization systems. In a preferred embodiment radio transmitters are based on chips such as the Maxim MAX7044 which is a 300 MHz to 450 MHz High-efficiency crystal-based+13 dBm amplitude shift keying (ASK) transmitter having a 250 us oscillator start-up time and 40 nA standby current. The sonar receiving nodes are preferably powered by a long-life battery such as a 3-volt lithium coin cell and all components have very low (i.e. micro-amp level) leakage current and CMOS circuitry, including op-amp TLV2764 with 20 uA per channel supply current and a unity gain of 500 KHz. Sonar receiving nodes preferably remain powered on with their ultrasonic receivers actively waiting for acoustic waves from robot 70, at which time the MAX7044 powers up, its oscillator starts, and the CMOS circuitry serially transmits a selectable identifier to the MAX7044 for modulated data transmission. For a 303 MHz carrier, and while using a 9.84375 MHz crystal, the CLKOUT clock signal is 615.2 KHz, which when divided by 8 provides a 76,900 bits per second data rate.

Other preferred embodiments use Bluetooth Low Energy (BLE) nodes instead of the narrowband radio chips described above. Use of these requires a time-synchronization technique for accurate measurement of time-of-flight readings.

The sensor network is used to for trilateration computations. Note that the time-of-flight between radio waves and acoustic waves differ by six orders of magnitude due to the differences in the speed of light (300,000,000 meters per second) and the speed of sound (344 meters per second). The time-of-flight of the radio waves are well below the sensing threshold of the electronics used in the present invention. Since acoustic energy dissipates over distance according to the square law, the amplitude of the reflected ping wave front is reduced by the distance to the fourth power.

Navigation through an RFID-tagged facility requires that the position and attitude of robot 70 be known. Preferred aerial scanning systems include reference points and signaling methods that relate to the position and attitude of robot 70 relative to those reference points. Types of references and signaling methods use radio waves and or acoustic waves. Types of radio waves include GPS signals, Wi-Fi signals, narrowband, spread spectrum, and ultra wideband (UWB) signals. Preferred embodiments also use micro-machined 3-axis 3D accelerometers, gyroscopes, and barometer, and magnetometers to sense acceleration, angular velocity, and heading and feeding those sensor measurements into computer 16 where control loops and estimator algorithms run. In a preferred embodiment computer 16 is an ODROID-XU4 from Hardkernel Co. Ltd. Of South Korea, having Samsung Exynos5422 Cortex™-A15 2 Ghz and Cortex™-A7 Octa core CPUs. Preferred embodiments include sensors such as ST Micro LSM303D 14-bit accelerometer and magnetometer, ST Micro ST Micro L3GD20H 16-bit gyroscope, Invensense MPU 6000 3-axis accelerometer/gyroscope, and MEAS MS5611 barometer.

Preferred control loops and estimator algorithms are available and adapted for use with robot 70 from open source autopilot developer communities such as PX4 and Paparazzi. Both are open-source autopilot systems oriented toward inexpensive autonomous aircraft. PX4 flight stack module source code is available at https://github.com/PX4/Firmware/tree/master/src/modules.

Another preferred embodiment uses a Qualcomm Technologies Flight Platform based on Linux operating system, a Qualcomm Snapdragon 801 processor and 4K Ultra HD video, computer vision, navigation, and real-time flight assistance. Project Dronecode is porting PX4 to operate in multi-threaded embodiments that will run on symmetric multiprocessing (SMP) Qualcomm Hexagon under a Linux operating system.

In a preferred UWB embodiment a DecaWave ScenSor DWM1000 Module is used for an indoor positioning system. DWM1000 is an IEEE802.15.4-2011 UWB compliant wireless transceiver module based on DecaWave's DW1000 IC. DWM1000 enables the location of objects in real time location systems (RTLS) to a precision of 10 cm indoors.

In a preferred embodiment a combination of narrowband or spread spectrum radio signals within an appropriate frequency band and acoustic waves as taught herein where a radio signal is used to indicated time of arrival of an acoustic ping at a remote sensing location. Time-of-flight of acoustic waves is used to compute distances with raw accuracy on the order of 1 centimeter.

Range measurements from stationary reference points are preferably used in trilateration computations to determine robot 70 position and attitude. A preferred trilateration calculation method uses four points where one point will be the origin (0, 0, 0), one point will lie on the x-axis (p, 0, 0), and one will lie on the xy-plane (q, r, 0). The fourth point will have an arbitrary location (s, t, u). This results in the following equations for x, y, and z where “Sq(p)” for example means p to the power of 2 and SqRt( ) is the square root operation:

x=(Sq(d1)−Sq(d2)+Sq(p))/2p

y=(Sq(d1)−Sq(d3)+Sq(r)+Sq(q)−(q(Sq(d1)−Sq(d2)+Sq(p))/p)/2r

z=+/−SqRt((Sq(d1)−Sq((Sq(d1)−Sq(d2)+Sq(p))/2p))−Sq((Sq(d1)−Sq(d3)+Sq(r)+Sq(q)−(q(Sq(d1)−Sq(d2)+Sq(p))/q)/2r))

Using a nominal conversion factor of 147 us per inch, the distance covered by a wave front traveling at the speed of sound is 50 ms/147 us, which equals 340 inches or 28.34 feet.

Other preferred embodiments of the present invention include cameras for photography, retail store surveillance, and for reading barcodes. Barcode decoding algorithms including open source algorithms. In a preferred embodiment a Samsung 5 Mpixel K5ECG MIPI CSI sensor is used for capturing still images or videos.

In a preferred embodiment, robot 70 have an API for shoppers to take control of BIS 10 or 80 for amusement and for shoppers taking photos of themselves and their friends inside or outside of the retail store (i.e. “selfies”). In that embodiment retail stores benefit from attracting customers and making it fun for shoppers to use this in conjunction with social media to show their friends the clothes, footwear, or handbag that they are interested in at that retail store, thus attracting additional business from the shoppers' friends.

In a preferred embodiment LIDAR sensors, such as LIDAR-Lite from PulsedLight, Inc. of Bend, Oreg. are used for determining the range to surrounding objects, people, or fixtures.

In other preferred embodiments RADAR is used to scan the area surrounding BIS 10 using GHz range scanning technology that is adapted for UAV use from companies that include Silicon Radar GmbH of Frankfurt, Germany. The 122 GHz FMCW frontend contains a 122 GHz SiGe transceiver chip fabricated in IHP SG13S SiGe BiCMOS technology, transmit and receive antenna (LCP substrate)—bonded in a standard pre-mold open cavity QFN package covered by a special lid. The IC is an integrated transceiver circuit for the 122 GHz ISM-band with antennas. It includes a low-noise-amplifier (LNA), quadrature mixers, poly-phase filter, Voltage Controlled Oscillator with digital band switching, divide by 32 circuit and power detector.

Preferred embodiments include simultaneous localization and mapping (SLAM) functions for constructing or updating a map of an unknown environment while simultaneously keeping track of the location of robot 70 within the map. Preferred embodiments use a particle filter or an extended Kalman filter.

In a preferred embodiment, use a Lidar that emits laser light, preferably in the 600 to 1000 nm wavelength range. A laser diode is focused through a lens apparatus and directed using microelectromechanical systems (MEMS) mirrors for example. Preferred laser beam scan patterns include general forward-looking patterns, sweeping the area in front of the UAV, or patterns that sweep through broader angles including a full 360-degree field of view. Raster scan patterns sweep through yaw and azimuth angles. A Lidar receives and analyzes the reflections off of objects that surround robot 70. Return light is amplified and processed to create a map or to determine the position of robot 70 within an existing map for navigation.

In preferred embodiments for retail stores stationary location references are used for navigation by robot 70 or mobile aerial RFID scanner 90. Stationary location references preferably use overhead lighting, including fluorescent, LED, or incandescent lighting emit sufficient energy in the form of light, electrostatic fields, or heat that can be harvested to power a stationary location reference.

Stationary location references using light for electrical power preferably use solar cells such as monolithic photovoltaic strings CPC1824 or monocrystalline KXOB22_01X8F, both manufactured by IXYS, are examples of preferred solar cells that convert photons from indoor fluorescent lighting into electric current. These energy harvesting devices preferably store electrons in energy storage devices such as capacitors or supercaps.

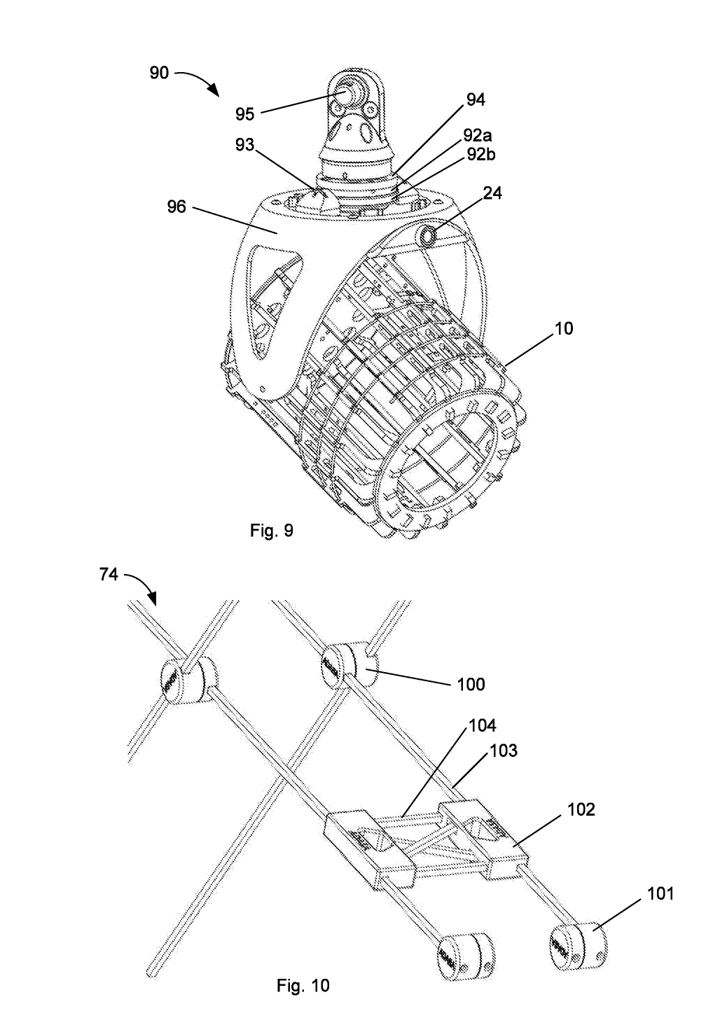

Using a shaft encoder, robot 70 or mobile aerial RFID scanner 90 measures the angle of the direction in which it is transmitting a laser beam from laser 24 of FIG. 2 or 9 relative to the body of the robot. Laser 24 rotates as antenna housing 25 or bracket 96 rotates through yaw angles, scanning the area around it.

In a preferred embodiment, robot 70 or mobile aerial RFID scanner 90 rotates a laser line from a laser 24 such as a 980 nm 60 mW laser line module from Lilly Electronics. The line is oriented in a vertical direction such that it is swept by the rotation of housing 25 of FIG. 2 or bracket 96 of FIG. 9 around in a circle that surrounds robot 70 or mobile aerial RFID scanner 90.

In a preferred embodiment of a mobile aerial RFID scanner 90, a laser line from laser 24 is swept about a vertical axis to create a vertically oriented stripe of coherent laser light that rotates around mobile aerial RFID scanning platform 90. The angular rotation position of the laser line is determined by using angular measurement devices such as a shaft encoder, or angular rate devices such as a gyroscope in combination with an absolute position measurement device such as a Hall effect sensor and magnet that together produce a signal that indicates a reference angle of the laser line. Preferred embodiments use a Hall effect sensor for sensing magnetic flux from a magnet on a rotating element that points the laser line. Additional Hall sensors, magnets, or magnetic pole sensors can be added to produce additional points of reference. An optical encoder, such as an absolute encoder can also be used to indicate reference angles of the angular rotation position of the laser line. Preferred embodiments use such devices to generate a microprocessor-compatible signal that indicates at lease one reference angle of the laser line.

Preferred embodiments comprise robot navigation reference points positioned such that mobile aerial RFID scanning platforms have a line of sight for a laser line to strike PIN photodiodes, preferably OSRAM BPW 34 FA silicon PIN photodiodes each with a daylight optical filter. Such a photodiode is responsive to light from 730 to 1100 nm with a spectral sensitivity peak at 880 nm.

Since the mobile aerial RFID scanning platform 90 is to operate indoors or outdoors, the photodiode laser light detection circuit must be capable of rejecting ambient light such as sunlight, incandescent, LED, or fluorescent light. In preferred embodiments, the photodiodes are arranged in differential pairs, both receiving nearly equal amounts of ambient light. Preferred detection circuits have a transimpedance amplifier using a low power op amp for each photodiode, the outputs of which are connected to a difference amplifier that subtracts the common mode signal noise, leaving only the differential signal, which is then amplified and/or fed into an analog comparator for pulse thresholding and edge squaring. The resulting signal preferably feeds into a second comparator pair, one to detect positive pulses, the other to detect negative pulse from the difference amplifier. The final outputs are two signals fed into two inputs to a microprocessor.

In another embodiment, a Bluetooth Low Energy (BLE) module is used at each stationary reference location. In a preferred embodiment a Microchip BM70 is used to time the pulse arrival times and report them to robot 70 or a mobile aerial scanner 90 over a Bluetooth link. A timer in the BM70 processor measures the time of arrival of the pulse. Then too when the laser strikes the second photodiode, which is in a preferred embodiment located only 2 inches to the side of the first photodiode, the time of that pulse is also measured and recorded. By comparing the times of the strikes to the reference time and angular velocity that are known by robot 70, the angles are computed for the laser path from robot 70 or mobile aerial scanner 90 to each of the two photodiodes. From those two angles and the triangles formed by them along with forward and lateral reference lines, the location of robot 70 or mobile aerial scanner 90 is estimated. Accuracy is dependent on the accuracy of each measurement. Preferred embodiments use several such photodiode reference point modules to report laser strike observations such that robot 70 or mobile aerial scanner 90 combines the aggregate of the location estimates to improve the accuracy of the fused triangulation estimate.

In one embodiment, the controller of robot 70, such as an Intel Compute Stick is used for triangulation computations for computing the location of a transponder. The location of the transponder is computed using the law of sines. Then using the known locations of robot 70 or mobile aerial scanner 90 along with its various antenna positions is preferably converted into a store-level coordinate system such as Cartesian coordinates with an x,y,z ordered triplet of axes to record the location of transponders. If the tag is a location transponder that marks location coordinates, then the location of robot 70 or mobile aerial scanner 90 is back-calculated and updated. Robot 70 preferably uses accelerometers, gyros, and shaft encoders on wheels 71a and 71b to sense motion, acceleration, posture, and dead reckoning movement to estimate the position of robot 70 between location tag readings and location references.

In a preferred embodiment, a brushless DC gimbal motor, driven by a sine wave waveform for each motor phase is used to smoothly sweep an aerial RFID scanning platform about a vertical axis, similar to how such a gimbal motor would sweep a camera along a yaw arc about a vertical axis to point a camera to a desired camera angle.

Extremely precise position localization accuracy for location of the mobile aerial RFID platform is attained when laser line sweep angles, also referred to as bearings are measured accurately. For example if a reference angle origin is zero degrees and coincides with the straight-ahead forward XY vector, then any laser line sweep angle measured from that reference angle would preferably be accurate to less than one degree. Preferred embodiments of the gimbal motor driver monitors motor phase current in each of the three motor phases to more accurately control phase current and minimize velocity ripple. Matching the mass and inertia of antenna bracket 96 and antenna 10 preferably damps the velocity ripple. The MEMS gyro preferably measures any remaining velocity ripple so that it can be accounted for when computing the vector sweep angles to the stationary location references.

Referring to FIG. 9 gimbal head pitch pivot mount 95 assures that as the scan head is elevated by an expandable folding structure, the rotating scan platform, laser 24, and antenna support bracket 96 remain in an upright, vertical orientation.

Preferred embodiments use a continuous motion of the gimbal motor rather than a back and forth motion. Continuous rotary motion is preferably enabled by the use of slip rings to transfer electrical power across the continuously rotating axis. Preferred embodiments use electrically conductive bands of copper foil 92a and 92b wrapped around a plastic housing 94 at the outer perimeter of the gimbal motor and spring-loaded contacts at commutator 93 to make electrical contact with the conductive bands, conducting electrical current into the scanning platform where electrical energy is preferably stored in an energy storage device by capacitors such as supercaps. In a preferred embodiment a magnet is embedded in a cavity of the plastic housing 94 to mark a defined reference angle. As the magnet passes by a Hall effect sensor mounted to the scanning platform, an electrical pulse is generated that marks that reference angle. A MEMS gyroscope such as an L2G21S from ST Micro is preferably attached to the same scanning platform, monitoring angular rate. A processor accepts as inputs to it signals from both the Hall sensor and the gyro to estimate an instantaneous angular position that is associated with any particular time during the time that the scanning platform rotates. The processor also preferably receives data from stationary location references that transmit the arrival times of laser light; from that and the time-based angular position described above, the instantaneous sweep angle is determined. The sweep angle is a navigation vector that points to stationary location reference for triangulation. If the stationary location reference has two photodiodes reporting laser line arrival times, then times from both detectors contribute to a triangulation estimate.

A preferred embodiment for maintaining charge for powering the stationary location reference is to shed loads until a mobile aerial RFID scanner approaches, as indicated by detection of an RFID interrogation signal. A passive RFID carrier signal detection circuit uses a UHF antenna, such as a dipole antenna for receiving RFID interrogation signals. The antenna feeds a voltage doubler wherein the voltage doubler comprises series-connected zero bias Schottky detector diodes. The output of the voltage doubler produces a signal with sufficient voltage to trigger a sleeping circuit, which in preferred embodiments is a low power CMOS microcontroller such as an NXP MC9S08 series microcontroller with an interrupt input that causes the microcontroller to exit a STOP state. In a STOP state nearly no current is flowing from the energy storage device until signals from the voltage doubler activate a device such as a microcontroller that is in a low-power state, which upon activation also activates low-power amplifiers and comparators in photodiode detector circuits.

A preferred radio transmitter for reporting when laser light strikes the at least one photodiode is MAX7044 from Maxim Integrated Products, and is preferably used to transmit a short burst of encoded data at a frequency in the 300 MHz to 450 MHz range. The burst of data preferably contains information that identifies the fixed location reference. The burst is sent at a fixed or deterministic time after the first photodiode is illuminated by laser light, and the time of flight of the radio signal is insignificant. Therefore the time of arrival of the transmitted burst corresponds closely with the time of the first photodiode illumination. The navigation system is preferably configured such that only one photodiode is illuminated at any one time. Therefore only one fixed location reference has a transmitter that is actively transmitting at any one time, resulting in an optically arbitrated radio protocol.

A radio receiver such as a MAX1473 from Maxim and a processor on the mobile aerial scanner platform receives and correlates the reported times that the laser line strikes each photodiode or photodiode pair with the angle of the laser line relative to a reference angle on the scanning platform. Each angle is processed in a triangulation algorithm to estimate the XY location of the scanning platform. For a complete XYZ location, the height of the mobile aerial RFID scanning platform is used.

The height of the mobile aerial RFID scanning platform is determined by an aerial lift mechanism in which the degree of expansion of an expandable folding structure, on the top of which rests the mobile aerial RFID scanning platform. Preferred embodiments use carbon fiber rods as lightweight structural members for the expandable folding structure. Preferred embodiments use ball bearing joints at the ends of the carbon fiber rods and near the middle of each to form a scissor lift.

Four lift bars 73 are preferably driven by two gear motors that rotate from a nominally horizontal angle to an elevated angle of approximately 70 degrees. Scissor lift members 74 are attached through pivots to lift bars 73 and expand vertically and collapse in response to movement of the lift bar motors. Significant heights of scan head 20 or mobile aerial scanner 90 are realized by adding more lift members 74.

As the carbon fiber structure expands, the degree of deployment is directly proportional to the angles of the base member lift bars 73 of the scissor lift. Preferred embodiments use an accelerometer on two base member lift bars to measure the angles of vertical deployment. The vertical height Z is calculated from those angular measurements and the lengths of the carbon fiber members.

In a preferred embodiment various lengths of 3 mm×3 mm hollow carbon fiber rods are used to construct a strong lightweight expandable folding structure; preferred embodiments are a scissor lift, a detailed section of which is shown in FIG. 10. Hollow carbon fiber rods 103 preferably serve as a conduit for electrical wires to power electronic aboard mobile aerial scanner 90. Brackets 102 are used to retain cross members 104 in a triangular shape so that scissor lift 74 retains its shape. End pivots 101 and mid-section pivots 100 are all preferably constructed with ball bearings for smooth motion.

In another embodiment, scissor lift 74 members are preferably strong, light, and able to conduct electric current to scan head 20 for recharging the battery or super capacitor. Preferred embodiments of scissor lift members 74 use materials such as carbon fiber rods or long thin printed circuit (PC) boards made from FR4 fiberglass. PC boards with dimensions of approximately 0.25″×21.5″ preferably use conductive traces to conduct charging current to scan head 20. Members 74 each have three pivot holes with metal plating; one hole at each end of each PC board and one hole in the middle to form the scissor lift structure.

Two-wheeled robot 70 uses a variable pitch RFID scanning antenna such as scan head 20 to direct an RFID interrogation field to selected vectors. Pitch axis 22a and 22b are supported by antenna support structure 21. Push rod 23 is preferably driven by a wing servo, causing antenna 10 to pivot to various controlled pitch angles. A small gear motor that rotates housing 25 controls the yaw angles for antenna 10 and laser 24 for triangulation measurements in support of robot localization.

Scan head 20 has a battery or super capacitor to store energy that is used to drive the RFID interrogator, a data collector, a pitch axis motor, and a yaw axis motor. Preferred embodiments of the data collector use an Intel Edison that provides an ARM processor, a small form factor with Bluetooth, Wi-Fi, and adequate memory to store RFID records.

Preferred embodiments use wires such as half-hard 16 AWG brass wire soldered between the PC boards to form intersecting triangles for structural strength.

Cameras are also preferably used with tracking the centroid of optical references, optical flow, and vanishing point navigation to recognize and guide a path for robots through aisles. Optical flow is the pattern of apparent motion of objects, surfaces, and edges in a retail store caused by the motion of the camera. Vanishing point navigation uses the parallel lines of store aisle, shelves, windows, and overhead lighting rails to compute a distant target, such as the end of an aisle; it also provides visual angular alignment for squaring the robot for accurate triangulations and transponder location measurements.

Beams and optical patterns of various types are dispersed through the surrounding space in order to provide an optical point of reference. In some embodiments dispersion is achieved using motion, moving mirrors, and/or other optical elements. In other embodiments, dispersion is achieved using fixed optical elements.

The RFID reads from various vantage points and selected vectors as an aggregate prevent missing any transponders from among a plurality of transponders that prior art readers would miss by either lack of illumination or blinding reflections from the interrogation field. Preferred embodiments use narrow RF interrogation beams, formed by high gain antennae that greatly reduce the magnitude of reflections from off-axis signal vectors that prior art solutions typically receive and process from a plurality of responsive transponders, resulting in ambiguity of the transponders' actual locations; an ambiguity that greatly confounds tag location efforts.

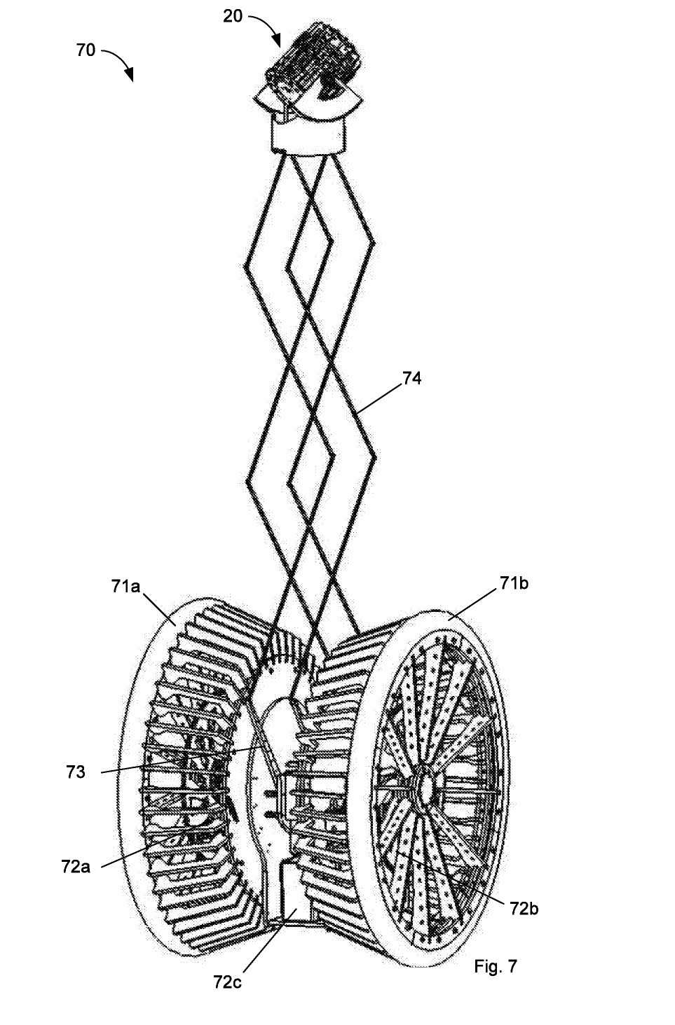

Robot 70 reads the identity and actual locations of RFID-tagged merchandise. Robot 70 as shown in FIG. 7 determines the locations of tagged goods in retail stores. In this preferred embodiment, there are two wheels 71a and 71b that independently rotate in either a clockwise or counter-clockwise direction to create forward or reverse motions of robot 70 or in opposing directions for a route turn or rotation of robot 70 about a fixed point on the floor.

Battery 72c is mounted below axles of wheels 71a and 71b to provide a low center of gravity; the result is inherent stability, unlike that of a classic inverted pendulum robot or a Segway human transporter.

As robot 70 traverses a retail sales floor or inventory storage areas, it may from time to time encounter obstacles in an otherwise flat surface. Robot 70 is preferably comprised of accelerometers and a three-axis gyroscope that detects changes in position and angular orientation. A robot controller such as a tablet, iPad, ODROID XU4, or Intel Compute Stick preferably detects and responds to changes in orientation under the control of algorithms that take into account the duration of the disturbance and historically related information. Controller 70 preferably learns by recording previous encounters with obstacles at certain locations, and reuses successful maneuvers to escape from known obstacles.

Robot 70 is preferably comprised of proximity sensors such as sonar modules to detect obstacles and boundaries. Sonar modules preferably report range to objects that reflect acoustic waves and enable robot 70 to stop or to take evasive action. Escape maneuvers of robot 70 preferably include reversing, pivoting, and changing direction to go around obstacles such as walls, furniture, and movable objects.

The controller preferably communicates with an RFID reader located within housing 25 using a wired or wireless connection. Information from the RFID reader is preferably collected and stored. In a preferred embodiment, SGTINs are associated with location information. In some embodiments, location is information is augmented by reading fixed location RFID transponders that are encoded with location codes.

Transponder location information preferably references a system or references points that extend beyond the boundaries of the room or space in which robot 70 is operating. A plurality of transponders can therefore have a distance between them that is greater than the physical dimensions of the space that they are contained within. For example, in a preferred embodiment, RFID location transponders are encoded with high-resolution longitude and latitude information. A preferred location identifier for an RFID transponder uses GPS coordinates. Such a location system is preferably used to track the locations of goods on a global scale.

A database preferably collects transponder identities and locations from robot 70 and others like it in facilities around the world. The robots periodically upload data to the database as Wi-Fi, 3G, or 4G wireless services are available.

The database preferably comprises means to report the locations of associated transponders to consumer devices wherein the associations are defined by characteristics of the objects that the transponders are attached to. The associations preferably comprise characteristics that include and are defined by fashion, style, or personal preferences. The database preferably accounts for fashion and style changes and alters the associations so that consumers will be more likely result to buy.

In this and other embodiments the narrow beam improves transponder location accuracy by reducing off-axis reads and reflections that confound tag location efforts. When an aggregate number of such reads are processed using triangulation, then the resulting tag location accuracy is greatly improved over prior art systems, methods, and devices.

In preferred embodiments motors for wheels 71a and 71b are polyphase brushless DC (BLDC) motors such as three-phase BLDC motors with Hall effect sensors or back EMF sensing to sense the angular velocity and position of the rotor. Exemplary motors are 100 to 500 watt hub motor measuring about 5 to 9 inches in diameter that benefit from mass production for e-bikes that have become globally popular, whereby driving costs down. Preferred embodiments of robot 70 use motors that have sufficient torque and traction to climb ramps and stairs in order to successfully scan all parts of multi-level environments. Due to the lack of brushes, BLDC motors will not spark, making them better suited for use in environments where there are volatile chemicals or fuels.

Micro-stepping of BLDC motors using sine-cosine phasing is used in preferred embodiments. Micro-stepping motor drives preferably include a torque feedback loop that controls the current through an H-bridge on each phase using phase current modulation such as pulse width modulation (PWM) to switch phase current on and off in a controlled manner, allowing freewheel current to circulate through a freewheeling diode for each phase as the magnetic flux gradually subsides in a current waveform that resembles a saw tooth. Preferred embodiments use coreless motors with Litz wire coil windings to reduce eddy current losses and wheel weight. Current and therefore torque delivered to motors is preferably controlled by a proportional-integral-derivative (PID) control loop.

Wheels 71a and 71b preferably have spokes to a rim for holding a tire such as a Bell Solid Tube NoMorFlat tire for bicycles. The spokes preferably provide an axle height above the floor that enables sufficient clearance for counterbalancing mass and weight to be placed below the axle whereby moving the center of gravity for the entire robot 70 below the axles. In preferred robot embodiments batteries 72a-c comprise a significant part of that counterbalancing mass and weight. Lead acid, LiNiMnCo, LiFePO4, lithium phosphate, or lithium-ion batteries deliver 20-50 amps to wheel motors in preferred embodiments of batteries 72a-c.

Preferred embodiments of robot 70 include self-aligning recharge connections for parking robot 70 in a location where it can guide itself to recharge batteries 72a-c. In preferred embodiments, batteries 72a and 72b are moved fore or aft to shift the center of gravity of robot 70, maintain balance and an upright position.

In preferred embodiments, high gain antenna 20 rotates to generate multiple beam path vectors that result in multiple read occurrences for triangulation computations to reliably determine the location of each detected transponder. Preferred embodiments use a shaft encoder to measure the angle of antenna housing 25 relative to a body of robot 70.

Referring to robot 70 of FIG. 7 and the mobile aerial scanning platform of FIG. 9, antenna 10, driven by a motor rotates about its yaw axis to provide the item level inventory count and location accuracy that is demanded by retailers and needed for multi-channel shopping. The antenna must be swept in a methodical and controlled manner for triangulation computation as described above.

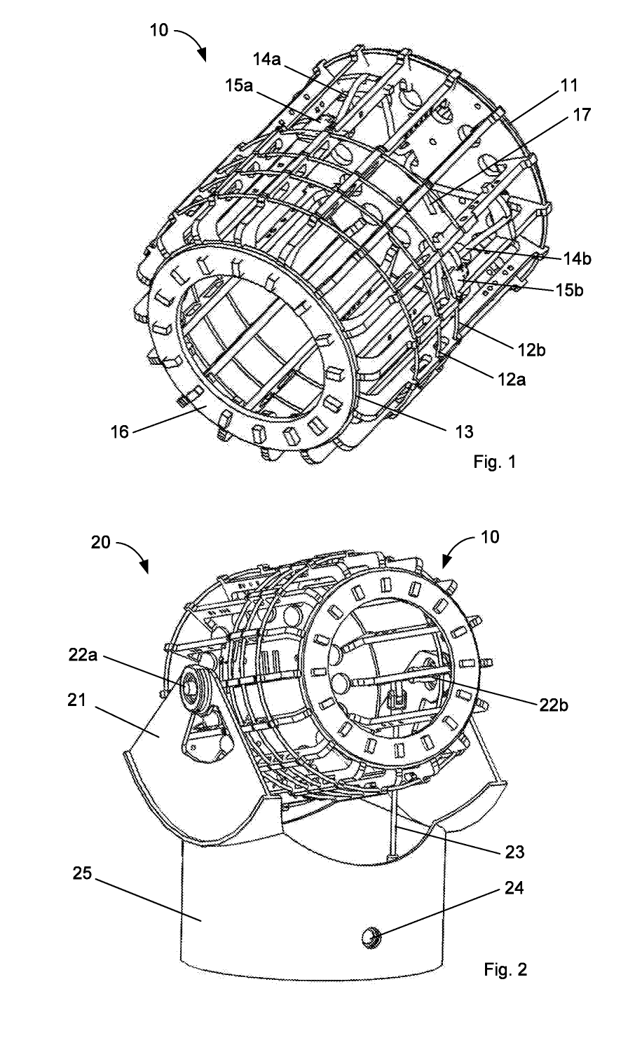

Preferred embodiments of item-locating mobile aerial RFID scanners use of narrow beam, high gain, directional antenna 10 shown in at least FIGS. 1, 2, 7, and 9 directed along selected vectors in order for the triangulation computations to be valid and accurate. In preferred embodiments, the antenna gain has a minimum of 8 dBic in order to form a narrow interrogation field from an RFID interrogator coupled with the antenna, for reading tags in a narrow sector of RFID-tagged inventory items at any one time. This narrowly focused beam reduces the probability that a scan will be blinded by un-modulated carrier being reflected into the receiver or for off-axis transponders to confound location by being illuminated and responsive to the carrier beam. Preferred embodiments detect amplifier saturation from blinding reflections and record the beam vector and location of blinding carrier reflections. Avoidance of or saving points of location reference are preferred uses of that stored information, enabling multi-dimensional alignment of scans from day to day.

Inventory rounds are preferably swept across the tag from multiple angles, preferably using a high gain antenna in order to reduce the magnitude of location error.

Intermediate transponder location data preferably comprises transponder observations that are used for triangulation computations. Scan results are preferably reported in stages, the second stage comprising: SGTIN; observation point (i.e. location of robot x,y,z); viewing angle (elevation and azimuth); and RF power level (db). Each stage is stored and processed to produce a computation of each tag's location using a descriptor comprising: SGTIN; and computed X, Y, Z Cartesian location. The processing comprises the steps of:
1) Match all first stage SGTIN observations and consolidate the detection records
2) Match any second stage observations to the consolidated first stage records
3) Combine the first and second stage records by formulating the three dimensional vector for both stages and compute the Cartesian point of intersection.
4) Match the result to any previous result of computed X, Y, Z location in a third stage. If there are no matches, then store as final stage transponder location data.

While the invention has been particularly shown and described with reference to certain embodiments, it will be understood by those skilled in the art that various changes in form and detail may be made without departing from the spirit and scope of the invention.

I claim:

1) A stationary location reference for mobile aerial RFID scanning platform navigation comprising:
a UHF antenna for receiving RFID interrogation signals;
a voltage doubler for sensing an approaching mobile aerial RFID scanner,
wherein the voltage doubler comprises zero bias Schottky detector diodes;
at least one photodiode for detecting laser light from the mobile aerial RFID scanner;
a radio transmitter for reporting to the mobile aerial RFID scanner when laser light strikes the at least one photodiode;
an energy storage device for powering the navigation reference point.

2) The stationary location reference of claim 1 further comprising at least one solar cell for harvesting photons for conversion into electrical energy for storage in the energy storage device.

3) The stationary location reference of claim 1 further comprising a second photodiode for detecting laser light.

4) The second photodiode of claim 3 further comprising a difference amplifier to receive signals from the two photodiodes wherein the two signals subtract from each other to remove common mode signal noise.

5) The stationary location reference of claim 1 wherein the transmitter sends data when the photodiode is illuminated by laser light.

6) The stationary location reference of claim 1 wherein the laser light is formed into a line and swept about a vertical axis on the mobile aerial RFID scanner.

7) The stationary location reference of claim 1 wherein signals from the voltage doubler activate a device that is in a low-power state.

8) A mobile aerial RFID scanner comprising:
a directional RFID antenna;
an RFID reader for interrogating RFID transponders;
a motor for rotating the directional antenna about a yaw axis;
an aerial lift mechanism for lifting the aerial RFID scanner;
a robot for moving the aerial lift and RFID scanner.

9) The mobile aerial RFID scanner of claim 8 further comprising a line laser for illuminating a plurality of stationary light detectors for determining the location of the mobile aerial RFID scanner.

10) The mobile aerial RFID scanner of claim 8 wherein the aerial lift mechanism comprises an expandable folding structure.

11) The mobile aerial RFID scanner of claim 8 wherein the expandable folding structure comprises carbon fiber rods.

12) The mobile aerial RFID scanner of claim 8 wherein the motor is a brushless DC gimbal motor.

13) A localization system for determining the location of a mobile aerial RFID scanning platform comprising:
a directional RFID antenna mounted to the mobile scanning platform;
an RFID interrogator connected to the RFID antenna;
a line laser mounted to the mobile scanning platform for producing a vertical line of coherent light;
a motor for sweeping the vertical line and the directional RFID antenna about a yaw axis on the mobile scanning platform;
a measurement device for determining the sweep angle of the vertical line;
a plurality of stationary location references with photo detectors for detecting coherent light from the vertical laser line;
a radio transmitter connected through circuitry to each detector of the plurality of stationary location references for detecting and reporting laser light illumination and detection times;
a radio receiver on the mobile platform for receiving the time of detection;
a processor connected to the radio receiver on the mobile aerial RFID scanner platform for computing the sweep angle associated with each reported time of detection for each reporting detector and for computing the location of the mobile aerial RFID scanning platform relative to the locations of the plurality of detectors.

14) The position localization system of claim 13 wherein the plurality of photo detectors are powered by energy-harvesting solar cells.

15) The position localization system of claim 13 wherein the measurement device for determining the sweep angle of the vertical line comprises a gyroscope for measuring angular rate.

16) The position localization system of claim 13 wherein the plurality of stationary location references have photodiodes arranged in differential pairs.

17) The position localization system of claim 13 wherein the transmitter begins transmitting when the line of coherent laser light strikes any of the photodiodes to which it is connected.

18) The position localization system of claim 13 wherein the plurality of stationary location references' circuitry are activated by a passive radio signal detector responsive to RFID interrogation signals.

19) The position localization system of claim 13 further comprising a signal that indicates at least one reference angle of the laser line.

20) The input of claim 19 further comprising a Hall effect sensor for sensing magnetic flux from a magnet on a rotating element that points the laser line.
